(19) United States
(12) Patent Application Publication
(10) Pub. No.: US 2016/0003461 A1
(43) Pub. Date: Jan. 7, 2016

(54) LUMINARE HAVING MULTIPLE SENSORS AND INDEPENDENTLY-CONTROLLABLE LIGHT SOURCES

(71) Applicants: Chi Gon CHEN, Roanoke, TX (US); INTERNATIONAL DEVELOPMENT LLC, Roanoke, TX (US)

(72) Inventor: CHI GON CHEN, GUANG ZHOU (CN)

(73) Assignee: INTERNATIONAL DEVELOPMENT LLC, ROANOKE, TX (US)

(21) Appl. No.: 14/770,048

(22) PCT Filed: Feb. 25, 2014
(86) PCT No.: PCT/US14/18242

§ 371 Date: Aug. 24, 2015

Related U.S. Application Data
(60) Provisional application No. 61/768,825, filed on Feb. 25, 2013.

(51) Int. Cl. F21V 23/04

(52) U.S. Cl. CPC F21V 23/0464; F21V 23/0471; F21Y 2101/02

(57) ABSTRACT

A lighting device includes a first light source having a first light source switch and a first light element array, and a second light source having a second light source switch and a second light element array. The lighting device also includes a light sensor and a motion sensor. The lighting device includes light sensor control circuitry that receives input from the light sensor and provides a first enable signal to the first light source based at least in part on the input from the light sensor. The lighting device also includes motion sensor control circuitry that receives input from the motion sensor and provides a second enable signal to the second light source based at least in part on the input from the motion sensor.

This application claims the benefit of U.S. Provisional Application No. 61/768,825, filed 25 Feb. 2013, which is hereby incorporated herein by reference.

### TECHNICAL FIELD

The present disclosure relates to luminaires, particularly luminaires capable of sensing and reacting to external motion and light.

### SUMMARY

Systems and methods of the present disclosure apply to many different types of luminaires that are capable of detecting and responding to external motion, such as security light fixtures equipped with motion sensors. Aspects of the present disclosure include a luminaire having a plurality of light sources, where one of the light sources is activated in response to a light sensor and another of the light sources is activated in response to a motion sensor.

According to some embodiments, a luminaire can include first and second light sources. The first light source provides “dusk to dawn” lighting, meaning that the first light source is activated in response to a light sensor that detects low ambient light conditions, for example at dusk, and remains activated until the light sensor detects high ambient light conditions, for example at dawn. The second light source can be controlled so that the second light source is only activated if motion is detected between dusk and dawn, i.e., during a period of time when low ambient light conditions are detected by the light sensor. In some embodiments, the first light source can remain activated while the second light source is activated. Alternatively, in some embodiments the first light source can be deactivated during the period of time when the second light source is activated. The first and second light sources preferably include respective groups of one or more light emitting elements. The light emitting elements are preferably light emitting diodes (LEDs), but other types of light emitting elements can be used.

In some embodiments, the lumen output of the first light source can be less than the lumen output of the second light source. For example, in some embodiments, the lumen output of the first light source can be less than half the lumen output of the second light source. In some such embodiments, the lumen output of the first light source can be less than one fourth the lumen output of the second light source. In some such embodiments, the lumen output of the first light source can be about one sixth the lumen output of the second light source.

### BRIEF DESCRIPTION OF THE DRAWINGS

Features, aspects, and embodiments of the present disclosure are described in conjunction with the attached drawings, in which:

FIGS. 1A, 1B, and 1C show respective views of an embodiment of a lighting device according to the present disclosure, where FIG. 1A shows a side view of the lighting device,

FIG. 1B shows a front view of the lighting device, and FIG. 1C shows a control panel of the lighting device;

FIGS. 2A and 2B show alternative embodiments of the lighting device shown in FIGS. 1A-1C where the alternative embodiments include alternative arrangements of the light emitting elements;

FIG. 3 shows an alternative embodiment of the lighting device shown in FIGS. 1A-1C where the lighting device includes multiple light housings;

FIG. 4 shows a schematic block diagram of a first embodiment of a controller for the lighting devices disclosed herein;

FIG. 5 shows a schematic block diagram of an embodiment of a first light source of the lighting devices disclosed herein;

FIG. 6 shows a schematic block diagram of an embodiment of a second light source of the lighting devices disclosed herein;

FIG. 7 shows a more detailed schematic diagram of an embodiment of the first light source shown in FIG. 5;

FIG. 8 shows a more detailed schematic diagram of an embodiment of the second light source shown in FIG. 6;

FIG. 9 shows a schematic block diagram of an embodiment of light sensor control circuitry of the lighting devices disclosed herein;

FIG. 10 shows a more detailed schematic diagram of an embodiment of the light sensor control circuitry shown in FIG. 9;

FIG. 11 shows a schematic block diagram of a portion of an embodiment of the controller shown in FIG. 4; and

FIG. 12 shows a schematic block diagram of a second embodiment of a controller for the lighting devices disclosed herein.

### DETAILED DESCRIPTION

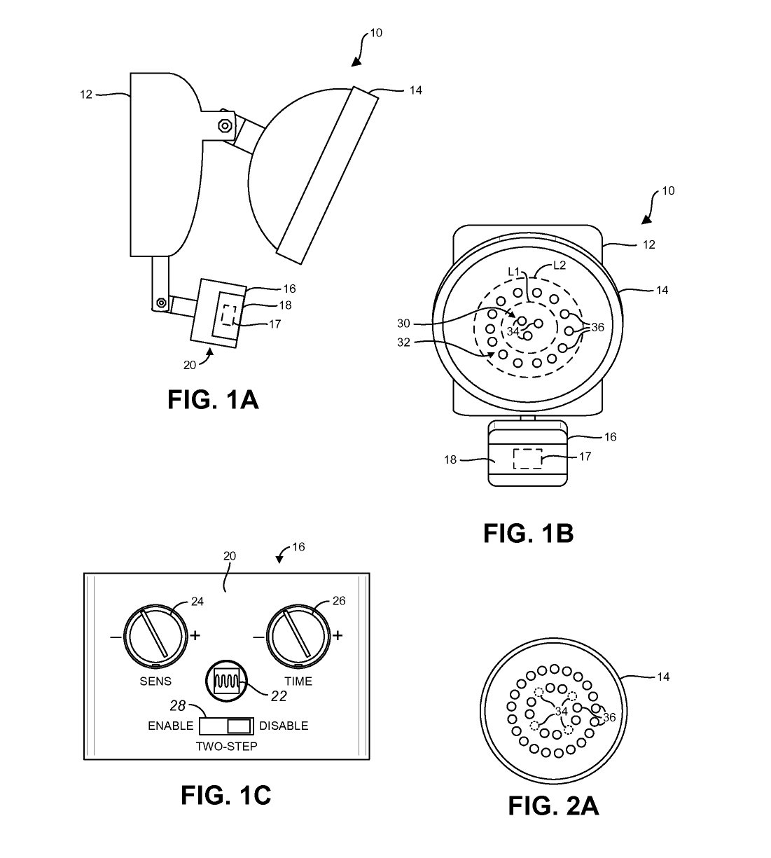

FIGS. 1A and 1B show side and front views, respectively, of an embodiment of a lighting device 10 according to the present disclosure. The lighting device 10 includes a control panel 20, which is shown in FIG. 1C.

The lighting device 10 is well-suited for use as a wall-mounted security light; however, alternative embodiments can be configured as any type of luminaire. For example, alternative embodiments can include: luminaires that are battery powered, solar powered, and/or adapted for connection to an external power source, such as a 110V or 220V electrical service; luminaires configured for indoor and/or outdoor use (dry, damp, and/or wet locations); and/or luminaires that are wall-mounted, post-mounted, track-mounted, ceiling-mounted, stake-mounted, and/or freestanding.

The lighting device 10 includes a base housing 12, a light housing 14, and a motion sensor housing 16. The light housing 14 and motion sensor housing 16 are both connected to the base housing 12. Preferably, the light housing 14 and the motion sensor housing 16 are connected to the base housing 12 via adjustable connections that are angularly and/or rotationally adjustable. Such adjustable connections are known that allow the positions of the light housing 14 and motion sensor housing 16 to be adjusted relative to the base housing 12 so that a user can direct the light housing 14 and motion sensor housing 16 toward desired locations.

The light housing 14 houses a first light source 30 and a second light source 32. The first light source 30 and second light source 32 are separately controllable to allow for the two-step functionality described herein, where the first and second light sources are activated in response to respective conditions. For example, the lighting device 10 can be configured such that the first light source 30 is activated/deactivated based on low-light conditions being detected by a light sensor 22, whereas the second light source 32 is activated/deactivated based on motion detected by a motion sensor 17 while low-light conditions are also being detected by the light sensor 22. The low-light condition can be any condition where the amount of light detected by the light sensor 22 falls below a turn-on light threshold level, which can be a factory preset threshold level or a threshold level that is adjustable by an end user.

Referring specifically to FIG. 1B, the first light source 30 comprises a first plurality of light emitting elements 34 and the second light source 32 comprises a second plurality of light emitting elements 36. The light emitting elements 34 and 36 are preferably LEDs, however other types of light emitting elements can be used. Also, in some embodiments, common-cathode or common-anode LEDs can be used that include two or more independently-controllable terminals (anodes in the case of common-cathode; cathodes in the case of common-anode). Such common-cathode or common-anode LEDs can include single-color emitting or multi-color emitting LEDs.

In some embodiments, the light emitting elements 34, 36 can all emit a same color of light, for example a white or substantially white light. Alternatively, the light emitting elements 34, 36 can include light emitting elements that can emit respective different colors of light. For example, in some embodiments, the color of the light emitting elements 34 can be more yellow or a warmer white than the white light emitted by the light emitting elements 36. In some such embodiments, the light emitting elements 34 can be dusk-to-dawn lights that respond to the light sensor 22 and emit light having a yellow or warm white color that is relatively unattractive to flying insects (e.g., light having a wavelength higher than about 650 nm), whereas the light emitting elements 36 can be responsive to the motion sensor and emit a more neutral or bluish color of white light.

In still more alternative embodiments, the light emitting elements 34, 36 can include color-changing light emitting elements. For example, in some embodiments, the first light source 30 can include color-changing light emitting elements that are controllable by a user such that the user can select from among a plurality of different colors through which the light emitting elements are capable of emitting, whereas the second light source 32 can include substantially white light emitting elements. In some such embodiments, the user can select a color to be emitted by light emitting elements 34 of the first light source 30 in response to the light sensor 22, and the white light can be emitted by light emitting elements 36 of the second light source 33 in response to the motion sensor 17.

In the illustrated embodiment, the first plurality of light emitting elements 34 are located within a first region, and the second plurality of light emitting elements 36 are located within a second region. The first region is within an area defined by the broken line L1. The second region surrounds the first region and is defined between broken lines L1 and L2.

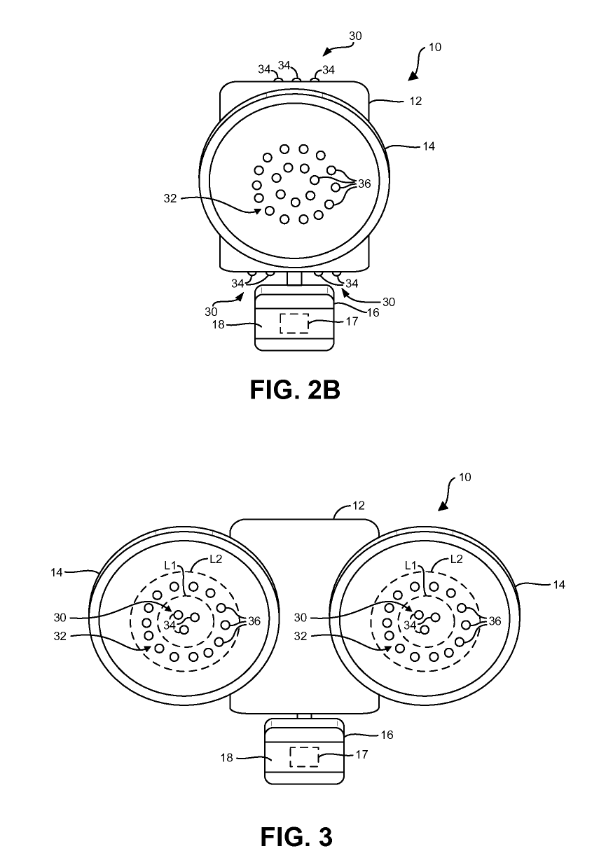

In alternative embodiments, the light emitting elements of the first and second light sources can instead be intermingled within a common region. For example, FIG. 2A shows an alternative embodiment where light emitting elements 34 (shown in broken lines) of the first light source 30 are intermingled with light emitting elements 36 (shown in solid lines) of the second light source 32.

In still further embodiments, at least some of the light emitting elements of the first and/or second light sources can be located somewhere on the lighting device 10 other than the light housing 14. For example, FIG. 2B shows an alternative embodiment where the light emitting elements 34 of the first light source 30 are located on the base housing 10, whereas the light emitting elements 36 of the second light source 32 are located on the light housing 14. In some such embodiments, the light emitting elements 34 can serve as wall washer lighting, while in other such embodiments the light emitting elements 34 can serve as accent lighting on any housing of the lighting device 10. Alternatively, some of the light emitting elements 34 of the first light source 30 can be located on the base housing 12, and others of the light emitting elements 34 of the first light source 30 can be located on the light housing 14 with the light emitting elements 36 of the second light source 32.

In some embodiments, the lumen output of the first light source 30 can be about the same as the lumen output of the second light source 32, while in other embodiments, the lumen output of the first light source 30 can be different than the lumen output of the second light source.

For example, in some embodiments, the lumen output of the first light source 30 can be less than the lumen output of the second light source 32. In some such embodiments, the lumen output of the first light source 30 can be less than half the lumen output of the second light source 32. In some such embodiments, the lumen output of the first light source 30 can be less than one fourth the lumen output of the second light source 32. In some such embodiments, the lumen output of the first light source 30 can be about one sixth the lumen output of the second light source 32.

In some embodiments, the lumen output of the first and/or second light sources 30 and/or 32 can be user-adjustable. In some such embodiments, controls can be provided to allow the user to adjust the lumen output of the first and/or second light sources 30 and/or 32 along a continuous brightness scale or by selecting from among two or more discrete brightness options. In some embodiments where the lumen output of the first and second light sources 30 and 32 are both user-adjustable, the respective lumen outputs of the first and second light sources 30 and 32 can be independently adjustable (e.g., the respective brightness levels of the first and second light sources 30 and 32 can be adjusted independently of one another by separate user controls); in other embodiments the respective lumen outputs of the first and second light sources 30 and 32 can be jointly adjustable (e.g., the brightness levels of the first and second light sources 30 and 32 can be adjusted together by a same user control).

While the embodiment of the lighting device 10 shown in FIGS. 1A-1C includes only a single light housing 14, alternative embodiments can include multiple light housings 14. For example, FIG. 3 shows an embodiment of the lighting device 10 having two light housings 14, each with respective first and second light sources 30 and 32. Alternatively, lighting device 10 can have multiple light housings 14 and any of the alternative arrangements of light emitting elements disclosed herein, such as intermingled light emitting elements or light emitting elements disposed on the base housing 12.

The lighting device 10 includes a motion sensor 17 supported by, and at least partially housed within, the motion sensor housing 16. The motion sensor 17 preferably comprises a pyroelectric infrared radial (PR) sensor, however other types of motion sensors can be used. The motion sensor housing 16 includes a motion sensor lens 18 through which the motion sensor 17 can detect motion.

The lighting device 10 also includes a light sensor 22. The light sensor 22 is supported by, and at least partially housed within, the motion sensor housing 16. Alternatively the light sensor 22 can be provided elsewhere. Preferably the light sensor 22 comprises a photocell, such as a light dependent resistor or photoresistor, however other types of light sensors can be used.

The control panel 20 for the lighting device 10 is preferably located on the bottom of the motion sensor housing 16. Alternatively, the control panel 20 can be located elsewhere on the lighting device 10, or the control panel 20 can be located remotely from the lighting device 10. The control panel 20 can include a variety of controls to allow a user to make adjustments to the operation of the lighting device 10. In the illustrated embodiment, shown only as one example, the control panel includes a sensitivity adjuster 24, a time adjuster 26, and/or a two-step switch 28. The sensitivity adjuster 24 allows a user to adjust the sensitivity of the motion sensor 17. The time adjuster 26 allows the user to adjust how long the second light source 32 should remain illuminated once motion has been detected by the motion sensor 17.

Alternative control panel layouts, configurations, and controls are possible. For example, in embodiments having color-changing light emitting elements 34 and/or 36, the control panel 20 can include controls for allowing a user to set the color of light being emitted.

In one such embodiment, for example, the control panel 20 can include a “bug mode” switch. The bug mode switch can include an ON position where the first light source emits light that is less attractive to insects, for example non-ultraviolet light or light having a wavelength higher than about 650 nm; the bug mode switch can also include an OFF position where the first light source emits light that is different in color than the light emitted when the bug mode is ON, such as light that is relatively more white or blue, such as light having a wavelength lower than about 650 nm.

The two-step switch 28 shown in FIG. 1C constitutes an example of a user-operable switch that allows a user to select from among a plurality of operation modes of the lighting device 10, and thereby control whether the two-step functionality described herein is enabled or disabled. While a multi-position switch is shown and described, alternative types of switches can be used, such as a toggle switch or the like that allows a user to cycle the lighting device 10 through the operation modes.

For example, in some embodiments, when the two-step switch 28 is in the “ENABLE” position, the first light source 30 acts as a “dusk to dawn” light while the second light source 32 is activated in response to motion detected from dusk to dawn. In other words, when the two-step switch 28 is in the “ENABLE” position, the first light source 30 is activated in response to the detection of low-light conditions by the light sensor 22 without regard to input from the motion sensor 17, and the second light source 32 is activated in response to the detection of motion by the motion sensor 17 while low-light conditions are being detected by the light sensor 22. In contrast, when the two-step switch 28 is in the “DISABLE” position, the first and second light sources 30 and 32 are activated together in response to motion detected from dusk to dawn. In other words, when the two-step switch 28 is in the “DISABLE” position, the first and second light sources 30 and 32 are only activated in response to the detection of motion by the motion sensor 17 while low-light conditions are being detected by the light sensor 22. Alternatively, when the two-step switch 28 is in the “DISABLE” position, the first light source 30 is disabled, and the second light source is only activated in response to the detection of motion by the motion sensor 17 while low-light conditions are being detected by the light sensor 22.

As another example, in some embodiments, when the two-step switch 28 is in the “ENABLE” position, the first light source 30 acts as a “dusk to dawn” light and the second light source 32 is activated in response to motion detected from dusk to dawn. In other words, when the two-step switch 28 is in the “ENABLE” position, the first light source 30 is activated in response to the detection of low-light conditions by the light sensor 22 without regard to input from the motion sensor 17, and the second light source 32 is activated in response to the detection of motion by the motion sensor 17 while low-light conditions are being detected by the light sensor 22. In contrast, when the two-step switch 28 is in the “DISABLE” position, the first and second light sources 30 and 32 are activated together in response to the detection of low-light conditions by the light sensor 22 without regard to input from the motion sensor 17. Alternatively, when the two-step switch 28 is in the “DISABLE” position, the first light source 30 is disabled, and the second light source is only activated in response to the detection of low-light conditions by the light sensor 22 without regard to input from the motion sensor 17.

Still further embodiments are possible, including embodiments where the two-step switch 28 has at least three positions. When the two-step switch 28 is in a first position, the first light source 30 acts as a “dusk to dawn” light and the second light source 32 is activated in response to motion detected from dusk to dawn. In other words, when the two-step switch 28 is in the first position, the first light source 30 is activated in response to the detection of low-light conditions by the light sensor 22 without regard to input from the motion sensor 17, and the second light source 32 is activated in response to the detection of motion by the motion sensor 17 while low-light conditions are being detected by the light sensor 22. When the two-step switch 28 is in a second position, the first and second light sources 30 and 32 are activated together in response to motion detected from dusk to dawn. In other words, when the two-step switch 28 is in the second position, the first and second light sources 30 and 32 are only activated in response to the detection of motion by the motion sensor 17 while low-light conditions are being detected by the light sensor 22. When the two-step switch 28 is in a third position, the first and second light sources 30 and 32 are activated together in response to the detection of low-light conditions by the light sensor 22 without regard to input from the motion sensor 17. Alternatively, when the two-step switch 28 is in the second position, the first light source 30 is disabled, and the second light source is only activated in response to the detection of motion by the motion sensor 17 while low-light conditions are being detected by the light sensor 22; and when the two-step switch 28 is in the third position, the first light source 30 is disabled, and the second light source is only activated in response to the detection of low-light conditions by the light sensor 22 without regard to input from the motion sensor 17.

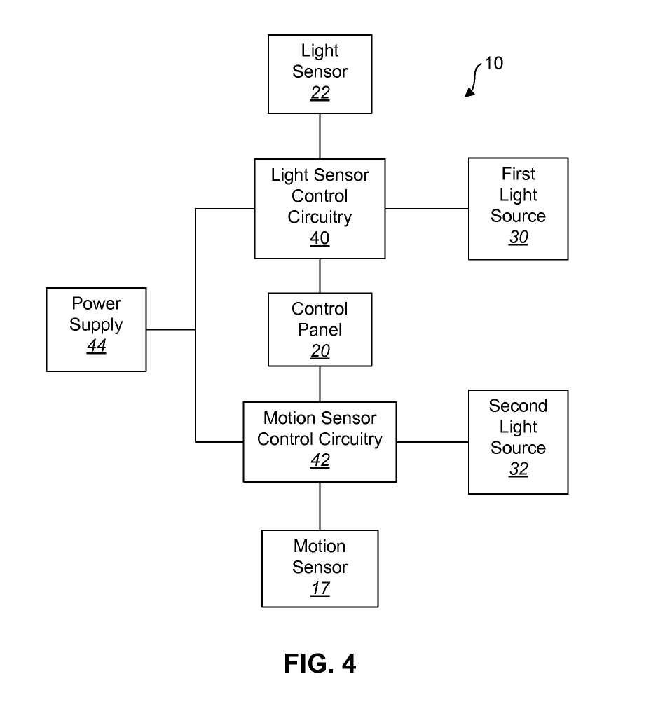

FIG. 4 shows a schematic block diagram of an embodiment of the lighting device 10. As discussed above, the lighting device 10 includes a light sensor 22 and a motion sensor 17. The lighting device 10 also includes light sensor control circuitry 40 that receives signals from the light sensor 22 and motion sensor control circuitry 42 that receives signals from the motion sensor 17. The light sensor control circuitry 40 and motion sensor control circuitry 42 both receive signals from the control panel 20 and electrical power from a power supply 44. The light sensor control circuitry 40 can control the first light source 30 according to signals from the light sensor 22 and the control panel 20. The motion sensor control circuitry 42 can control the second light source 32 according to signals from the motion sensor 17 and the control panel 20.

The power supply 44 can include terminals for connection to an external power source, such as a 110V or 220V electrical service line. The power source 44 can alternatively, or additionally, include one or more batteries that are replaceable and/or rechargeable. Embodiments that include rechargeable batteries can further include a solar panel and means for recharging the one or more batteries using electricity generated by the solar panel. The power supply 44 can also include known power conditioning and circuit protection components, for example one or more fuses, rectifiers, and/or voltage dividers.

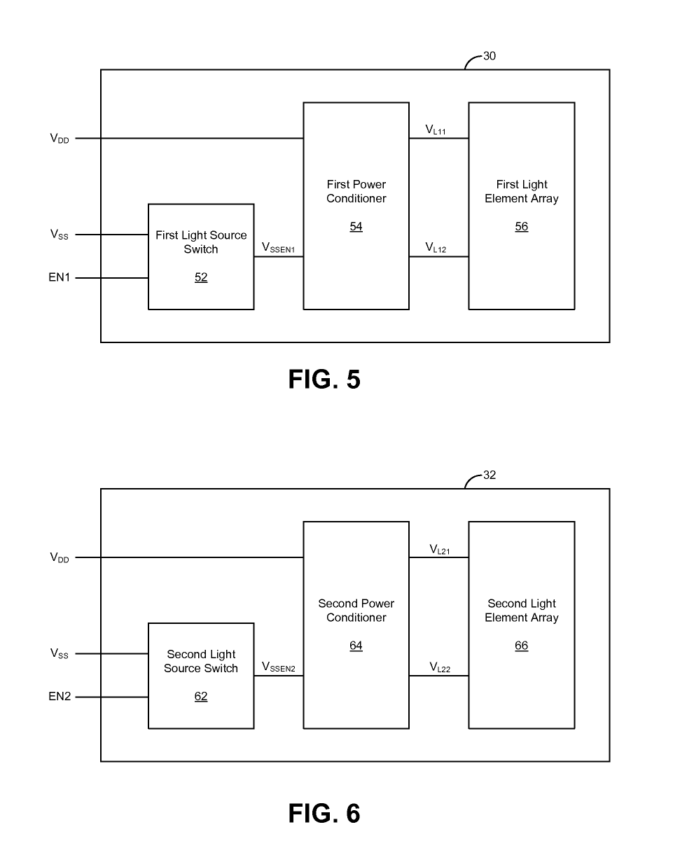

FIG. 5 shows a schematic block diagram of an embodiment of the first light source 30. The first light source 30 shown in FIG. 5 includes a first light source switch 52, a first power conditioner 54, and a first light element array 56. The first light source switch 52 receives a voltage V_{SS} and a first enable signal EN1 from the light sensor control circuitry 40. The first light source switch 52 provides a voltage signal V_{SSEN1} to the first power conditioner 54. The value of voltage signal V_{SSEN1} can vary depending on the value of the first enable signal EN1.

The first power conditioner 54 receives a voltage V_{DD} from the power supply 44. The first power conditioner 54 outputs a pair of voltages V_{L11} and V_{L12} to the first light element array 56. The voltage potential between voltages V_{L11} and V_{L12} depends on the value of voltage signal V_{SSEN1} received by the first power conditioner 54 from the first light source switch 52, which in turn depends on the value of the first enable signal EN1. Thus, the first enable signal EN1 can control the magnitude of the voltage potential provided to the first light element array 56.

The first light element array 56 can include one or a plurality of light elements, such as light elements 34. The plurality of light elements can include plural discreet light elements, such as plural discreet LEDs, or can include light elements having a common node. For example, a common-cathode LED having a plurality of separately-controllable anodes, or a common-anode LED having a plurality of separately-controllable cathodes, is considered to be a plurality of light elements. Also, the use of the term “array” in the first light element array 56 (and second light element array 66 described below) does not exclude embodiments where the first light element array 56 includes only a single light element. Use of the term “array” (and variations thereof, such as “subarray”) herein is not intended to be limiting to more than one unless explicitly indicated as such.

In some embodiments, the first light element array 56 can include one or more subarrays each having one or more light emitting elements, where each subarray is configured to emit respective different colors of light. In some such embodiments, switching elements, such as transistors, can be used for switching between the subarrays so that the color of light emitted by the first light source 30 can be varied. In some such embodiments, the switching elements can be controlled by one or more color selection signals issued from the light sensor control circuitry 40 to the first light source 30 based on user color-selection inputs at the control panel 20; in other such embodiments, the switching elements can be controlled by one or more color selection signals issued from the control panel 20 based on user color-selection inputs at the control panel 20.

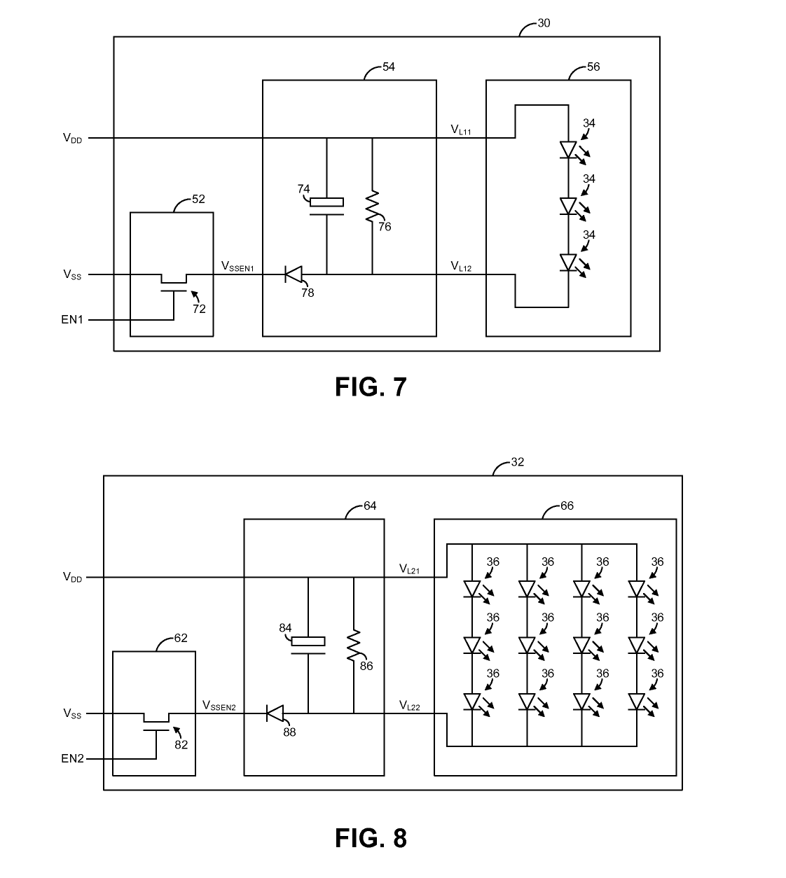

In some embodiments, such as the embodiment shown in FIG. 7 and described below, all of the light emitting elements of the first light element array 56 can emit substantially the same color of light.

If the amount of voltage provided to the first light element array 56 is at or above a threshold turn-on voltage level, the one or more light elements of the first light element array 56 will turn ON and emit light. Otherwise, if the amount of voltage provided to the first light element array 56 is below the threshold turn-on voltage level, the one or more light elements of the first light element array 56 will turn OFF and will not emit light.

Thus, the first enable signal EN1 can be used to control whether the one or more light elements of the first light element array are ON (emitting light) or OFF (not emitting light). Referring back to FIG. 4, the first enable signal EN1 can be issued from the light sensor control circuitry 40 to the first light source 30. The value of the first enable signal EN1 issued from the light sensor control circuitry 40 can depend on input received by the light sensor control circuitry 40 from the light sensor 22. For example, if the amount of light received by the light sensor 22 exceeds a turn-off ambient light threshold, the light sensor control circuitry 40 can detect this condition and issue a first enable signal EN1 to the first light source 30 having a value that causes the one or more light elements of the first light element array 56 to turn OFF. On the other hand, if the amount of light received by the light sensor 22 falls below a turn-on light threshold, the light sensor 22 can issue a signal to the light sensor control circuitry 40 indicative of such, and in turn the light sensor control circuitry 40 can issue a first enable signal EN1 to the first light source 30 having a value that causes the one or more light elements of the first light element array 56 to turn ON.

Thus, light elements of the first light source 30 can be controlled based exclusively, or at least in part, on the amount of light detected by the light sensor 22.

That is, in some embodiments the light elements of the first light source 30 can be controlled based exclusively on the amount of light detected by the light sensor 22, meaning that the light elements of the first light source 30 can be turned ON if the amount of light received by the light sensor 22 falls below a turn-on light threshold, and can be turned OFF if the amount of light received by the light sensor 22 exceeds a turn-off ambient light threshold.

In other embodiments, the light elements of the first light source 30 can be controlled based on the amount of light detected by the light sensor 22 in combination with other influences, such as input received by the light sensor control circuitry 40 from the control panel 20. For example, the control panel 20 can include a master ON/OFF switch that allows a user to disable the first light source 30 regardless of the amount of light detected by the light sensor 22.

Additionally or alternatively, the control panel 20 can include a mode of operation switch, such as the two-step switch 28, that allows a user to select from among a plurality of operation modes, including one or more operation modes that introduce one or more additional factors for determining conditions under which the first light source 30 should be activated and/or deactivated. For example, in some embodiments, the operation modes can include a user-selectable mode in which the lighting device 10 ignores the light sensor 22 and only activates one or both of the first and second light sources 30 and 32 based on input from the motion sensor 17. In such embodiments, light elements of the first light source 30 can be controlled based at least in part on the amount of light detected by the light sensor 22 and at least in part on input from the control panel 20.

FIG. 6 shows a schematic block diagram of an embodiment of the second light source 32. The second light source 32 shown in FIG. 6 includes a second light source switch 62, a second power conditioner 64, and a second light element array 66. The second light source switch 62 receives a voltage V_{SS} and a second enable signal EN2. The second light source switch 62 provides a voltage signal V_{SSEN2} to the second power conditioner 64. The value of voltage signal V_{SSEN2} depends on the value of the second enable signal EN2.

The second power conditioner 64 also receives a voltage V_{DD}. The second power conditioner 64 outputs a pair of voltage signals V_{L21} and V_{L22} to the second light element array 66. The voltage potential between voltage signals V_{L21} and V_{L22} depends on the value of voltage signal V_{SSEN2} received by the second power conditioner 64 from the second light source switch 62, which in turn depends on the value of the second enable signal EN2. Thus, the second enable signal EN2 can control the magnitude of the voltage potential provided to the second light element array 66.

The second light element array 66 can include one or a plurality of light elements, such as light elements 36. The plurality of light elements can include plural discreet light elements, such as plural discreet LEDs, or can include light elements having a common node. For example, a common-cathode LED having a plurality of separately-controllable anodes, or a common-anode LED having a plurality of separately-controllable cathodes, is considered to be a plurality of light elements. Also, the use of the term “array” in the second light element array 66 (and first light element array 56 described above) does not exclude embodiments where the second light element array 66 includes only a single light element. Use of the term “array” (and variations thereof, such as “subarray”) herein is not intended to be limiting to more than one unless explicitly indicated as such.

In some embodiments, the second light element array 66 can include one or more subarrays each having one or more light emitting elements, where each subarray is configured to emit respective different colors of light. In some such embodiments, switching elements, such as transistors, can be used for switching between the subarrays so that the color of light emitted by the second light source 32 can be varied. In some such embodiments, the switching elements can be controlled by one or more color selection signals issued from the motion sensor control circuitry 42 to the second light source 32 based on user color-selection inputs at the control panel 20; in other such embodiments, the switching elements can be controlled by one or more color selection signals issued from the control panel 20 based on user color-selection inputs at the control panel 20.

In some embodiments, such as the embodiment shown in FIG. 8 and described below, all of the light emitting elements of the second light element array 66 can emit substantially the same color of light.

If the amount of voltage provided to the second light element array 66 is at or above a threshold turn-on voltage level, the one or more light elements of the second light element array 66 will turn ON and emit light. Otherwise, if the amount of voltage provided to the second light element array 66 is below the threshold turn-on voltage level, the one or more light elements of the second light element array 66 will turn OFF and will not emit light.

Thus, the second enable signal EN2 can be used to control whether the one or more light elements of the second light element array are ON (emitting light) or OFF (not emitting light). Referring back to FIG. 4, the second enable signal EN2 can be issued from the motion sensor control circuitry 42 to the second light source 32. The value of the second enable signal EN2 issued from the motion sensor control circuitry 42 can depend on input received by the motion sensor control circuitry 42 from the motion sensor 17. For example, if the amount of motion detected by the motion sensor 17 exceeds a turn-on motion threshold (which can be preset or can be set by the user using the sensitivity adjuster 24), the motion sensor 17 can issue a signal to the motion sensor control circuitry 42 indicative of such, and in turn the motion sensor control circuitry 42 can issue a second enable signal EN2 to the second light source 32 having a value that causes the one or more light elements of the second light element array 66 to turn ON. Then, after a set period of time (which can be preset or can be set by the user using the time adjuster 26), if the amount of motion detected by the motion sensor 17 does not exceed a turn-on motion threshold, the motion sensor control circuitry 42 can issue a second enable signal EN2 to the second light source 32 having a value that causes the one or more light elements of the second light element array 66 to turn OFF. Accordingly, light elements of the second light source 32 can be controlled based exclusively, or at least in part, on the amount of motion detected by the motion sensor 17.

Thus, light elements of the second light source 32 can be controlled based exclusively, or at least in part, on the amount of motion detected by the motion sensor 17.

That is, in some embodiments the light elements of the second light source 32 can be controlled based exclusively on the amount of motion detected by the motion sensor 17. For example, some embodiments of the lighting device 10 can have fixed time and sensitivity thresholds rather than sensitivity and time adjusters 24 and 26 on the control panel 20. In such embodiments, the light elements of the second light source 32 can be turned ON if the amount of motion detected by the motion sensor 17 exceeds a preset turn-on motion threshold, and can be turned OFF if the amount of motion detected by the motion sensor 17 does not exceed a turn-on motion threshold for a preset amount of time.

In other embodiments, the light elements of the second light source 32 can be controlled based on the amount of motion detected by the motion sensor 17 in combination with other influences, such as input received by the motion sensor control circuitry 42 from the light sensor control circuitry 40 and/or from the control panel 20. For example, in some embodiments, the control panel 20 can include a master ON/OFF switch that allows a user to disable the second light source 32 regardless of the amount of motion detected by the motion sensor 17. As mentioned above, in some embodiments, the control panel 20 can include sensitivity and/or time adjusters 24 and 26. Also, in some embodiments, the lighting device 10 can be configured such that the second light source 32 is only activated if motion is detected at night. So, in such embodiments, the second light source 32 can be configured such that the second light element array 66 is only activated if motion is detected by the motion sensor 17 while the amount of light received by the light sensor 22 is below the turn-on light threshold.

Additionally or alternatively, the control panel 20 can include a mode of operation switch, such as the two-step switch 28, that allows a user to select from among a plurality of operation modes, including one or more operation modes that introduce one or more additional factors for determining conditions under which the second light source 32 should be activated and/or deactivated. For example, in some embodiments, the operation modes can include a user-selectable mode in which the lighting device 10 ignores the motion sensor 17 and only activates one or both of the first and second light sources 30 and 32 based on input from the light sensor 22. In such embodiments, light elements of the second light source 30 can be controlled based at least in part on the amount of light detected by the light sensor 22 and at least in part on input from the control panel 20.

FIG. 7 shows a schematic block diagram of an embodiment of the first light source 30 shown in FIG. 5. The first light source 30 shown in FIG. 7 includes examples of embodiments of the first light source switch 52, the first power conditioner 54, and the first light element array 56. Alternative embodiments of the illustrated components of the first light source 30 are possible for performing equivalent functions.

The first light source switch 52 includes a transistor 72 having a gate connected to receive the first enable signal EN1. The transistor 72 can be an N-channel transistor and operate as a pull-down device. When the voltage level of the first enable signal EN1 is high enough (e.g., equivalent to a Logic 1), the voltage signal V_{SSEN1} is pulled down to voltage V_{SS} (e.g., ground) by N-channel transistor 72.

The first power conditioner 54 includes a capacitor-connected transistor 74, a resistor 76, and a diode 78. The capacitor-connected transistor 74 acts to filter out any switching transients, and resistor 76 acts to set voltage and current conditions for the first light element array 56. Diode 78 acts as a protection diode to prevent reverse-current from damaging the first light element array 56.

The first light element array 56 includes a plurality of LEDs 34 connected in series. The illustrated embodiment includes three series-connected LEDs 34. Alternative embodiments can include any number of LEDs 34, which can be connected in series and/or in parallel in many different configurations according to circuit design configurations and driving characteristics of the LEDs 34.

FIG. 8 shows a schematic block diagram of an embodiment of the second light source 32 shown in FIG. 6. The second light source 32 shown in FIG. 8 includes examples of embodiments of the second light source switch 62, the second power conditioner 64, and the second light element array 66. Alternative embodiments of the illustrated components of the second light source 32 are possible for performing equivalent functions.

The second light source switch 62 includes a transistor 82 having a gate connected to receive the second enable signal EN2. The transistor 82 can be an N-channel transistor and operate as a pull-down device. When the voltage level of the second enable signal EN2 is high enough (e.g., equivalent to a Logic 1), the voltage signal V_{SSEN2} is pulled down to voltage V_{SS} (e.g., ground) by N-channel transistor 82.

The second power conditioner 64 includes a capacitor-connected transistor 84, a resistor 86, and a diode 88. The capacitor-connected transistor 84 acts to filter out any switching transients, and resistor 86 acts to set voltage and current conditions for the second light element array 66. Diode 88 acts as a protection diode to prevent reverse-current from damaging the first light element array 66.

The second light element array 66 includes a plurality of LEDs 36. The plurality of LEDs 36 includes four parallel sets of three series-connected LEDs 36. Alternative embodiments can include any number of LEDs 36, which can be connected in series and/or in parallel in many different configurations according to circuit design configurations and driving characteristics of the LEDs 36.

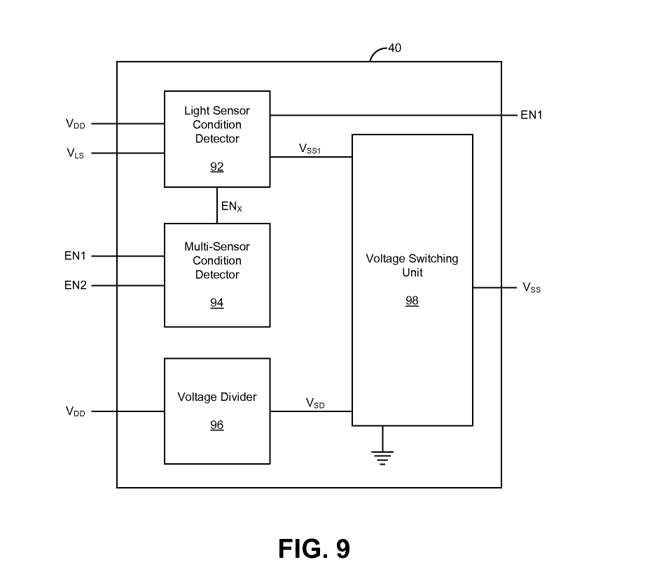

FIG. 9 shows a schematic block diagram of an embodiment of the light sensor control circuitry 40. The light sensor control circuitry 40 shown in FIG. 9 includes a light sensor condition detector 92, a multi-sensor condition detector 94, a voltage divider 96, and a voltage switching unit 98.

The light sensor condition detector 92 receives a light sensor voltage signal Vis from the light sensor 22. The light sensor condition detector 92 also receives an input operating voltage V_{DD}. The light sensor condition detector 92 outputs the first enable signal EN1, the value of which is based on the value of the light sensor voltage signal V_{LS} received from the light sensor 22. For example, the first enable signal EN1 can be relatively high (e.g., logic level 1) when the light sensor voltage signal V_{LS} is above a threshold turn-on voltage level, and the first enable signal EN1 can be relatively low (e.g., logic level 0) when the light sensor voltage signal V_{LS} is below a threshold turn-on voltage level.

The light sensor condition detector 92 also receives an enable condition signal EN_{X} from the multi-sensor condition detector 94. The light sensor condition detector 92 outputs a voltage signal V_{SS1}, the value of which is based on the value of the enable condition signal EN_{X} and the light sensor voltage signal V_{LS}. Thus, the light sensor condition detector 92 outputs signals EN1 and V_{SS1}, both of which are based at least in part on input from the light sensor 22.

The multi-sensor condition detector 94 receives the first and second enable signals EN1 and EN2, and outputs the enable condition EN_{X} signal based on the values of the first and second enable signals EN1 and EN2. In some embodiments, the multi-sensor condition detector 94 can include OR logic and can output the enable condition EN_{X} signal having a value equivalent to a logic level 1 if at least one of the first and second enable signals EN1 and EN2 has a value equivalent to a logic level 1; otherwise, the multi-sensor condition detector 94 can output the enable condition EN_{X} signal having a value equivalent to a logic level 0.

The voltage switching unit 98 receives the voltage signal V_{SS1} from the light sensor condition detector 92 and a voltage V_{SD} from the voltage divider 96. The voltage switching unit 98 outputs voltage V_{SS} to the first and second light sources 30 and 32. The value of the voltage V_{SS} is either equivalent to ground level voltage or the voltage V_{SD} depending on the value of voltage V_{SS1} received from the light sensor condition detector 92. For example, if V_{SS1} is equivalent to logic level 1, then the voltage V_{SS} can be ground level, whereas if V_{SS1} is equivalent to logic level 0, then the voltage V_{SS} can be equivalent to voltage V_{SD}.

As discussed above in connection with the description of the first and second light sources 30 and 32, when the voltage V_{SS} is sufficiently low, then the voltage potential provided to the light sources 30 and 32 is suitable for activating the respective set of light elements when enabled by the respective first or second enable signal EN1 or EN2. In the embodiment of the light sensor control circuitry 40 shown in FIG. 9, the voltage V_{SS} will be sufficiently low if low light is detected by the light sensor 22 (and the corresponding light sensor voltage Vis is provided to the light sensor condition detector 92) and one or both of the first and second enable signals EN1 and EN2 is enabled (e.g., logic level 1) as detected by the multi-sensor condition detector 94.

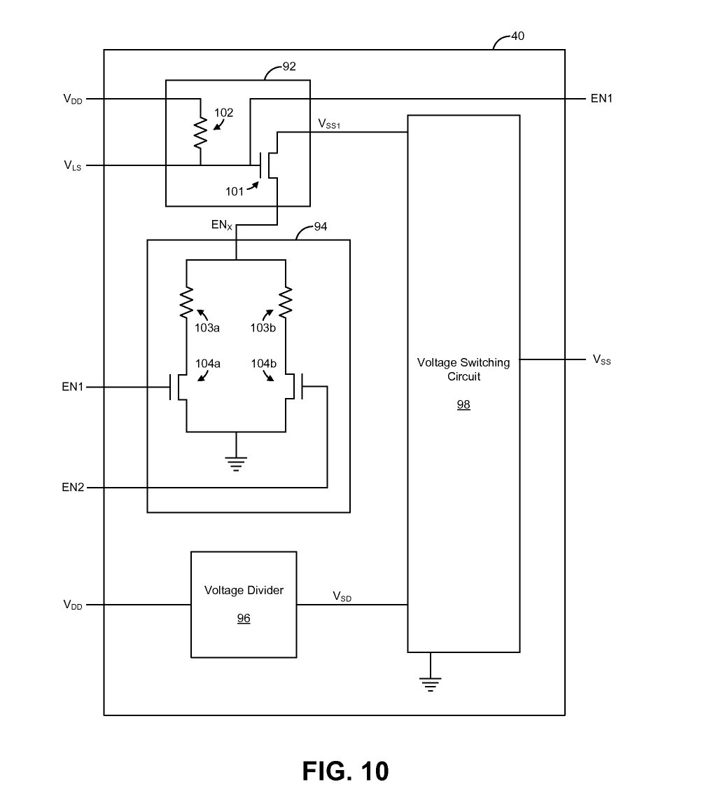

FIG. 10 shows a schematic block diagram of an embodiment of the light sensor control circuitry 40 shown in FIG. 9.

In the embodiment shown in FIG. 10, the light sensor condition detector 92 includes a transistor 101 and a resistor 102. In some embodiments, light sensor 22 can have a variable resistance that varies depending on the amount of light being detected by the light sensor 22. In such embodiments, the resistor 102 together with the light sensor 22 can act as a voltage divider such that the light sensor voltage V_{LS} varies depending on the amount of light being detected by the light sensor 22. The light sensor voltage V_{LS} is connected to the gate of the transistor 101 so that the state of the transistor 101 is dependent on the value of the light sensor voltage V_{LS}, thereby making the state of the transistor 101 dependent upon the amount of light being detected by the light sensor 22.

In some embodiments, the voltage V_{DD} can be controlled via a switch on the control panel 20, allowing the user to disable the input from the light sensor 20 by removing the voltage V_{DD}. Also, in such embodiments, the voltage V_{LS} can be switched to EN2 so that the lighting device 10 can be activated only in response to motion detected by the motion sensor 17 regardless of whether light is detected by the light sensor 22.

In the embodiment shown in FIG. 10, the multi-sensor condition detector 94 includes a first and second resistors 103a and 103b, and first and second transistors 104a and 104b. The first transistor 104a has a gate connected to receive the first enable signal EN1, and the second transistor 104b has a gate connected to receive the second enable signal EN2. Thus, a voltage drop across the first resistor 103a occurs if the first enable signal EN1 activates the first transistor 104a, and a voltage drop across the second resistor 103b occurs if the second enable signal EN2 activates the second transistor 104b. This allows the multi-sensor condition detector 94 to act as an OR circuit where the value of the output signal EN_{X} depends on whether at least one of the first and second enable signals EN1 and EN2 is at logic level 1.

The voltage divider 96 and voltage switching circuit 98 can be composed of conventional circuitry used to perform the functions described above. For example, the voltage divider 96 can include resistive and capacitive components selected and arranged to provide the desired voltage level V_{SD}.

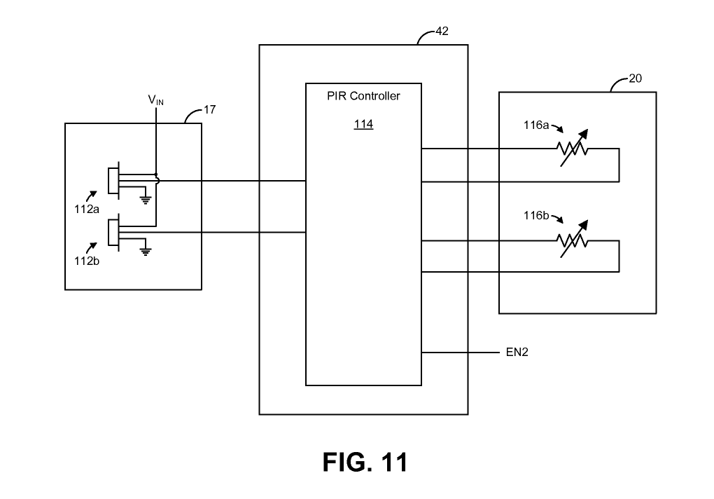

FIG. 11 shows a schematic block diagram of embodiments of the motion sensor 17, control panel 20, and motion sensor control circuitry 42 shown in FIG. 4. The motion sensor 17 can include first and second PIR sensors 112a and 112b, which each output respective signals to the motion sensor control circuitry 42 representative of detected motion. The motion sensor control circuitry 42 can include a conventional PIR controller 114, which receives the input signals from the PIR sensors. The control panel 20 can include a plurality of variable resistors for allowing the user to adjust characteristics of the motion sensor functionality. For example, the control panel 20 can include a first variable resistor 116a, which can be, for example, a first rotary potentiometer accessible to the user as the sensitivity adjuster 24 for adjusting sensitivity of the motion sensing functionality, and the control panel 20 can include a second variable resistor 116b, which can be, for example, a second rotary potentiometer accessible to the user as the time adjuster 26 for adjusting the on-time of the motion sensing functionality. The PIR controller 114 can output the second enable signal EN2 based on whether motion is sensed by the PR sensors 112a and 112b and based on any user settings sensed by the PIR controller 114 from the control panel 20.

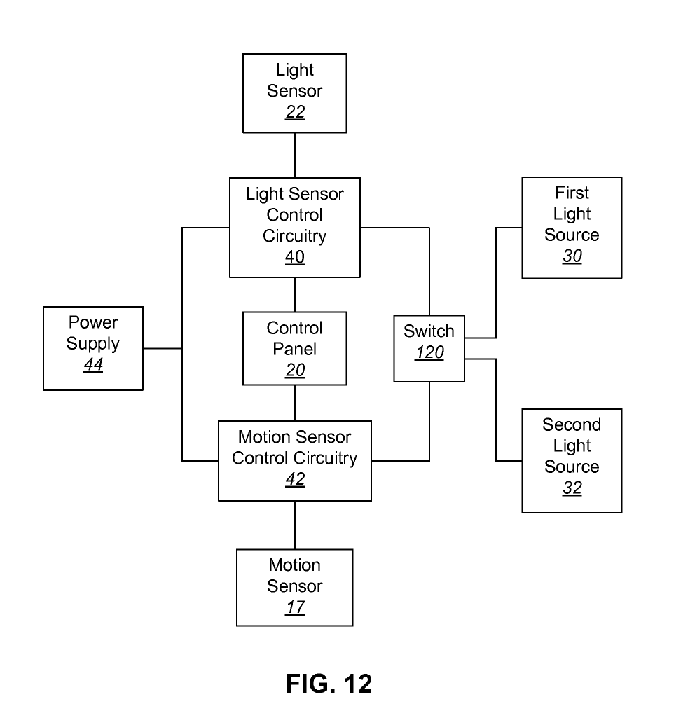

FIG. 12 shows a schematic block diagram of an alternative embodiment of the lighting device 10 shown in FIG. 4. The embodiment shown in FIG. 12 can be the same as other embodiments described herein, except that the embodiment shown in FIG. 12 includes a switch 120 that prevents both the first and second light sources 30 and 32 from being activated at the same time. In the embodiments shown in FIGS. 4 and 12, the first light source 30 is activated during low-light conditions as detected by the light sensor 22. In the embodiment shown in FIG. 4, when motion is detected by the motion sensor 17, the second light source 32 is activated along with the first light source 30. In contrast, in the embodiment shown in FIG. 12, when motion is detected by the motion sensor 17, the second light source 32 is activated and the first light source 30 is deactivated.

The switch 120 is connected to receive the first enable signal EN1 from the light sensor control circuitry 40 and the second enable signal EN2 from the motion control circuitry 42. When the switch 120 detects that the first enable signal EN1 is at logic level 1, the switch 120 relays the first enable signal EN1 to the first light source 30 so that it can be activated. When the switch 120 detects that the second enable signal EN2 is at logic level 1 while the first enable signal EN1 is still at logic level 1, the switch 120 blocks the first enable signal EN1 from reaching the first light source 30, and relays the second enable signal EN2 to the second light source 32. As a result, the first light source 30 is deactivated while the second light source is activated. Once the second enable signal EN2 changes back to logic level 0, if the first enable signal EN1 is still at logic level 1, the switch 102 deactivates the second light source 32 and relays the first enable signal EN1 to the first light source 30 so that the first light source 30 is activated.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A lighting device, comprising:
a first light source including a first light source switch and a first light element array;
a second light source including a second light source switch and a second light element array;
a light sensor;
a motion sensor;
light sensor control circuitry that receives input from the light sensor and provides a first enable signal to the first light source; and
motion sensor control circuitry that receives input from the motion sensor and provides a second enable signal to the second light source.

2. The lighting device of claim 1, wherein the first light element array includes a first plurality of light emitting diodes.

3. The lighting device of claim 2, wherein the second light element array includes a second plurality of light emitting diodes.

4. The lighting device of claim 1, wherein the light sensor comprises a photocell.

5. The lighting device of claim 1, wherein the motion sensor comprises a pyroelectric infrared radial (PIR) sensor.

6. The lighting device of claim 1, further comprising a user-operable switch allowing a user to select one of a plurality of operation modes, wherein the plurality of operation modes includes:
a first mode where the first light source is activated in response to the detection of low-light conditions by the light sensor without regard to input from the motion sensor, and the second light source is activated in response to the detection of motion by the motion sensor while low-light conditions are being detected by the light sensor.

7. The lighting device of claim 6, wherein the plurality of operation modes includes:
a second mode where the first and second light sources are only activated in response to the detection of motion by the motion sensor while low-light conditions are being detected by the light sensor.

8. The lighting device of claim 6, wherein the plurality of operation modes includes:
a second mode where the first light source is disabled, and the second light source is only activated in response to the detection of motion by the motion sensor while low-light conditions are being detected by the light sensor.

9. The lighting device of claim 6, wherein the plurality of operation modes includes:
a second mode where the first and second light sources are activated together in response to the detection of low-light conditions by the light sensor without regard to input from the motion sensor.

10. The lighting device of claim 6, wherein the plurality of operation modes includes:
a second mode where the first light source is disabled, and the second light source is only activated in response to the detection of low-light conditions by the light sensor without regard to input from the motion sensor.

11. The lighting device of claim 1, wherein the lumen output of the first light source is less than the lumen output of the second light source.

12. The lighting device of claim 11, wherein the lumen output of the first light source is less than half the lumen output of the second light source.

13. The lighting device of claim 1, wherein the light sensor control circuitry provides the first enable signal to the first light source when the light sensor detects an amount of light below a turn-on light threshold level.

14. The lighting device of claim 1, wherein the motion sensor control circuitry provides the second enable signal to the second light source when motion is detected by the motion sensor and the light sensor detects an amount of light below a turn-on light threshold level.

15. The lighting device of claim 14, further comprising a switch that blocks the first enable signal from the light sensor control circuitry while the motion sensor control circuitry provides the second enable signal to the second light source.
